(19) United States
(12) Patent Application Publication
(10) Pub. No.: US 2009/0314356 A1
(43) Pub. Date: Dec. 24, 2009

(54) PRESSURE RELIEF PLATE AND, PRESSURE RELIEF DEVICE AND GAS-INSULATED SWITCHGEAR USING THE SAME

(75) Inventors: Masanori Osumi, Chiyoda-ku (JP); Mikio Mori, Chiyoda-ku (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Chiyoda-ku (JP)

(21) Appl. No.: 12/403,457

(22) Filed: Mar. 13, 2009

(30) Foreign Application Priority Data
Jun. 20, 2008 (JP) 2008-161471

(51) Int. Cl. F16K 17/40

(52) U.S. Cl. 137/68.23

(57) ABSTRACT

In a conventional gas-insulated switchgear placed outdoors, a pressure relief plate of a pressure relief device-a component of the switchgear-becomes wet due to entering of rain or moisture to corrode and deteriorate; and the wet portions swell by their freezing, resulting in further deterioration in mechanical strength of the portions; therefore, the switchgear has a problem in long term reliability.

In order to prevent the surface of the pressure relief plate from being exposed to rain or moisture, a hydrophobic synthetic resin is adhered to the outside surface of the pressure relief plate that closes the pressure relief hole provided on the insulated switchgear; therefore, deterioration through corroding or the one in mechanical strength can be curbed to secure long term reliability of the gas-insulated switchgear.

### BACKGROUND OF THE INVENTION

1. Field of the Invention

The present invention relates to pressure relief plates that are mounted in gastight enclosures of gas-insulated switchgears or the like in order to prevent the pressure inside the enclosures from suddenly rising and bursting of the enclosures and relates to pressure relief devices and gas-insulated switchgears that use the relief plates.

2. Description of the Related Art

A pressure relief device mounted in a gastight enclosure of a conventional gas-insulated switchgear includes a pressure relief plate that closes a pressure relief hole formed in the gastight enclosure and bursts when pressure in the gastight enclosure rises to a predetermined one; a protective sheet that covers from outside the pressure relief plate and removes when the pressure is relieved; and a protective cover that prevents the pressure relief plate and the protective sheet from removing and flying apart. The central portion of the pressure relief plate is bent toward the inside of the enclosure and radially provided with trenches on the outside surface of the central portion to burst at a predetermined pressure (for example, Japanese Patent Laid-Open No. H8-140230 (paragraph 0013)).

The protective sheet used in the conventional pressure relief device is provided with a small hole in order to alleviate pressure change between the pressure relief plate and the protective sheet caused by changes in the outdoor temperature, and the protective cover is provided with an opening for releasing gases. The outer surface of the pressure relief plate is exposed to the outside air; therefore, especially when the gas-insulated switchgear is placed outdoors, the outer surface easily becomes wet due to entering of rainwater or moisture. For example, when the surface of the pressure relief plate is wet due to rain water, moisture and the like entering through the small hole or the opening, corrosion develops in a wet portion and the wet portion swells due to its freezing, resulting in deterioration in mechanical strength of the portion; therefore, the pressure relief device has a problem in long term reliability.

### SUMMARY OF THE INVENTION

The present invention aims to solve the problem described above and provide a pressure relief device and a gas-insulated switchgear, in which the pressure relief plate neither corrodes nor reduces its mechanical strength even when placed outdoors.

A pressure relief device according to the present invention has a pressure relief plate that closes a pressure relief hole formed in a gastight enclosure and bursts when pressure in the gastight enclosure rises to a predetermined value, to relieve the pressure, and a mounting means for fixing the plate to the gastight enclosure; and the pressure relief plate is provided with hydrophobic synthetic resin adhered to a surface thereof.

In the pressure relief device configured as described above according to the present invention, hydrophobic synthetic resin is adhered onto a surface of the pressure relief plate, so that the surface of the pressure relief plate is not directly exposed to the outside air. Therefore, rainwater and moisture neither corrode the surface of the pressure relief plate nor freeze on the surface, which can bring an effect of obtaining a pressure relief device and a gas-insulated switchgear that are not deteriorated in mechanical strength.

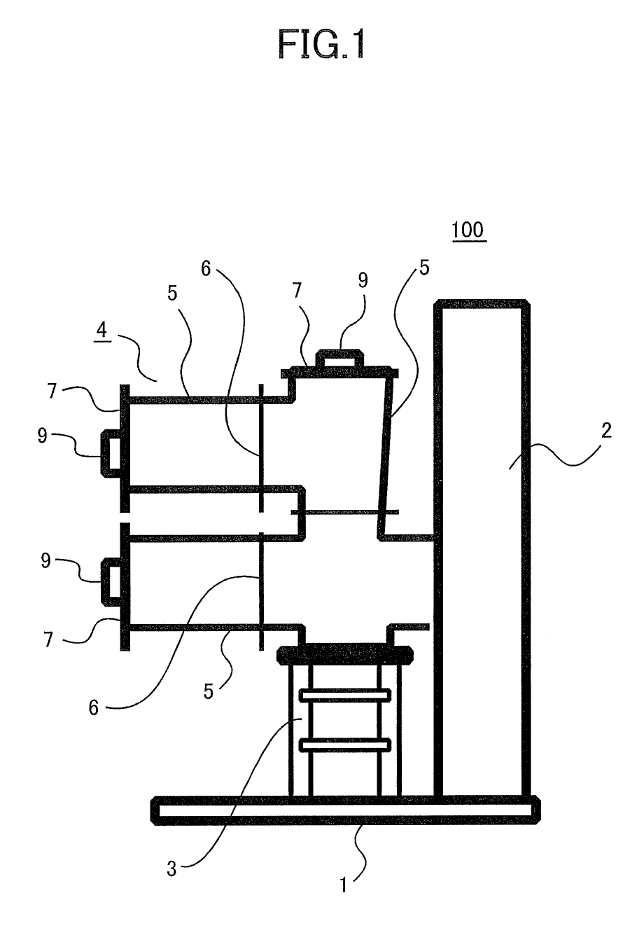

FIG. 1 is a sectional view of a gas-insulated switchgear according to the present invention;

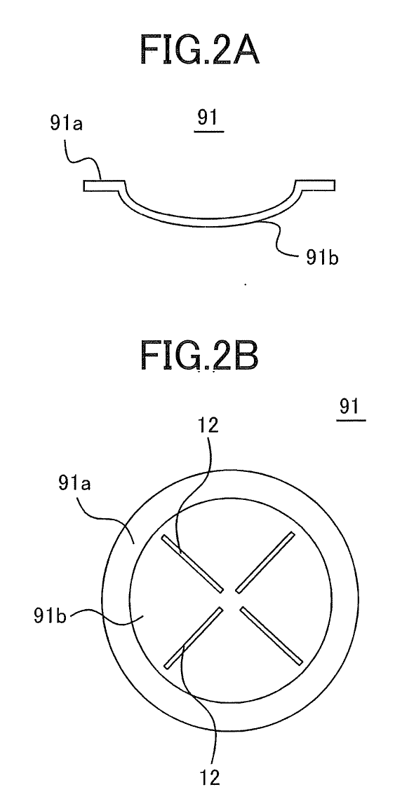

FIG. 2 include outlined views of a pressure relief plate used in a pressure relief device according to the present invention;

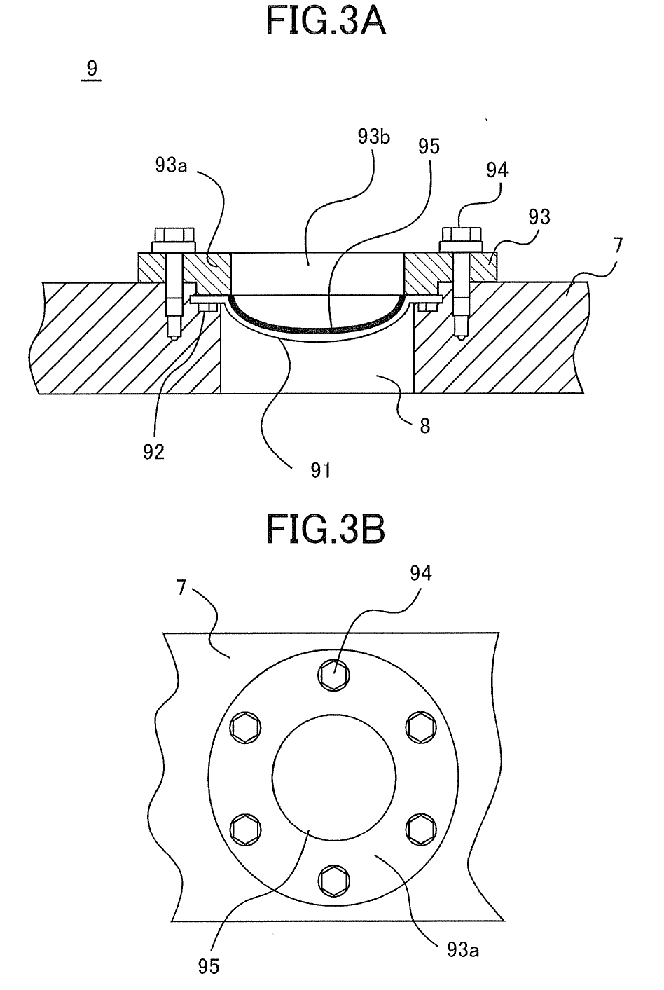

FIG. 3 include outlined views illustrating a pressure relief device, of Embodiment 1 according to the present invention, fixed to the gastight enclosure;

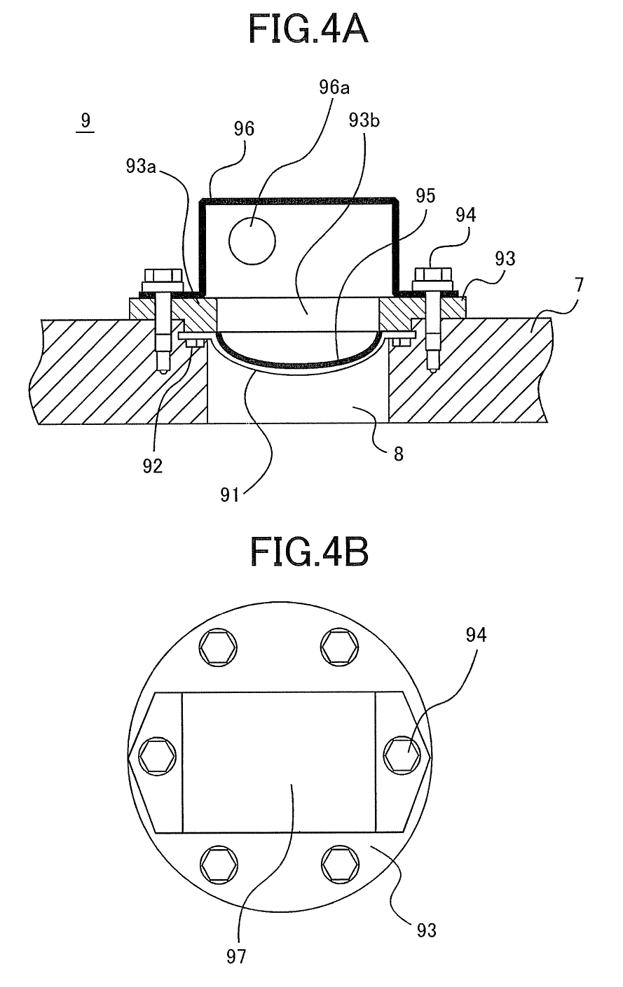

FIG. 4 include outlined views illustrating a pressure relief device, of Embodiment 4 according to the present invention, fixed to the gastight enclosure.

### DETAILED DESCRIPTION OF THE PREFERRED EMBODIMENTS

### Embodiment 1

Referring to views, Embodiment 1 according to the present invention will be explained in detail below. FIG. 1 is a sectional view illustrating a configuration of a gas-insulated switchgear using a pressure relief device according to the present invention. FIG. 2 include outlined views of a pressure relief plate used in the pressure relief device according to the present invention. FIG. 3 include outlined views illustrating the pressure relief device according to Embodiment 1 mounted on a gastight enclosure of the gas-insulated switchgear. In FIGS. 1 through 3, the components identical or equivalent to each other are referred to as the same numerals.

As shown in FIG. 1, the gas-insulated switchgear 100 according to the present invention includes a base 1, a control panel 2, support structures 3, and a gas-insulated-switchgear main body 4 that is mounted above the base 1 and supported by the control panel 2 and the support structures 3. The gas-insulated-switchgear main body 4 is separated into a plurality of gastight enclosures 5 by a plurality of gas barrier insulators 6; and the enclosures contain disconnecting switches, grounding switches, gas circuit breakers, buses and the like, not shown in the figure, at their predetermined positions. A gastight enclosure plate 7—an exterior portion of each gastight enclosure 5—has a pressure relief hole 8, not shown in the figure, and a pressure relief device 9 is mounted to close the pressure relief hole 8.

As shown in FIG. 2A, a side sectional view, a pressure relief plate 91 used in the pressure relief device 9 according to the present invention is in a hat shape that has a brim section (visor) 91a and a crown section 91b-a bent section in a central portion of the plate. As shown in FIG. 2B, a top view, four trenches 12 with their V-shaped cross section is provided in the concave-side surface of the crown section 91b, so that the trenches 12 first begin to tear when pressure imposed to the pressure relief device 9 reaches a predetermined value. In addition, the time when the imposed pressure reaches a predetermined value means a time when the pressure inside the gastight enclosure 5 of the gas-insulated switchgear 100, for example, rapidly rises due to grounding-fault discharging or the like and then becomes a pressure that bursts the pressure relief device 9 mounted on the gastight enclosure 5. The pressure at which the pressure relief plate bursts is a predetermined value designed in advance according to specifications required for the pressure relief device. Therefore, with respect to the trenches provided in the concave-side surface of the crown section 91b, the cross-section shape thereof is not necessarily in a V-shape, any cross-section shape may be allowed; the number of the trenches is not necessarily four, and is designed appropriately depending on the required specification.

As shown in FIG. 3A, a side sectional view, in order to close the pressure relief hole 8 provided in the gastight enclosure plate 7—the exterior portion of the gastight enclosure 5, the pressure relief device 9 according to the present invention is fixed to an outside peripheral portion of the hole. On a peripheral portion of the pressure relief hole 8, which is a portion of the outside surface of the gastight enclosure plate 7, an O-ring 92 is placed; and on the O-ring 92, a brim section 91a of the pressure relief plate 91 is mounted with the convex side of its crown section 91b inserted in the pressure relief hole 8. On the outside surface of the brim section 91a, an edge portion 93a of a circular attachment plate 93 is placed; the pressure relief plate 91 is fixed to the gastight enclosure plate 7, by putting bolts 94 through holes on the edge portion 93a to sandwich the plate. As shown in FIG. 3B-a top view, six bolts 94 are put through six holes provided on the edge portion 93a and then screwed into holes provided on the gastight enclosure plate 7 to fix the plate. Here, the concave side of the crown section 91b of the pressure relief plate 91 faces a hollow portion 93b of the attachment plate 93. A silicone resin 95—a hydrophobic synthetic resin—is adhered, by coating, to the concave-side surface of the crown section 91b. The concave-side surface of the crown section 91b and an inside end face of the edge portion 93a of the attachment plate 93 may be simultaneously coated with the silicone resin 95—hydrophobic synthetic resin—so that the synthetic resin is adhered, not terminated at the outer edge of the crown section 91b, to the pressure relief plate 91. This ensures that the synthetic resin is more securely adhered to the crown section 91b and brings easy coating operations as well.

In the pressure relief device of Embodiment 1 according to the present invention configured as described above, the silicone resin 95 is adhered, by coating, to the concave-side surface of the crown section 91b of the pressure relief plate 91; therefore, there occurs no incursion of rain water or moisture onto the concave-side surface of the crown section 91, which resultantly removes influences from rain water or moisture, obtaining a highly reliable pressure relief device without its mechanical strength reduction due to corrosion or freezing. That is, also in the gas-insulated switchgear 100 provided with the pressure relief device of Embodiment 1 according to the present invention, mechanical strength reduction due to corrosion and freezing by rainwater and moisture is less likely to occur, so that the switchgear can obtain high reliability. In addition, the hydrophobic synthetic resin used in Embodiment 1 according to the present invention is not necessarily the silicone resin; a synthetic resin—such as fluorine resin or fluorine rubber that include fluorine—may be used. These synthetic resins have very small surface energy, and are very slick and soft in their special features; therefore, when the crown section 91b of the pressure relief plate 91 is coated with the resin, which is adhered thereto, the resin does not affect the pressure at which the pressure relief plate 91 bursts. That is, the pressure relief device 9 provided on the gastight enclosure 5 has a feature in that the device bursts as soon as the pressure reaches the pressure at which the device is to burst.

In Embodiment 1, the silicone resin is dissolved in a solvent and the like, then the concave-side surface of the pressure relief plate 91 is coated therewith, so that the silicone resin 95 is adhered to the surface of the pressure relief plate 91; a method of adhering synthetic resin such as the silicone resin onto the surface of pressure relief plate is not limited to coating process. For example, a sheet of the hydrophobic synthetic resin may be adhered to the surface of pressure relief plate by heat welding, or by bonding with an adhesive; in short, any method is applicable as long as a protective layer such as a blocking film of a hydrophobic synthetic resin is formed on and closely adhered to the surface of the pressure relief plate.

### Embodiment 2

Embodiment 2 according to the present invention will be explained in detail below. While the concave-side surface of the crown section 91b of the pressure relief device in Embodiment 1 is entirely coated with the silicone resin 95, a pressure relief device of Embodiment 2 according to the present invention differs from that of Embodiment 1 in that only the trenches 12 in the concave-side surface of the crown section 91b and their neighboring areas are coated with the silicone resin 95 so as to fill the trenches with the resin.

In the pressure relief device of Embodiment 2 according to the present invention configured as described above, the silicone resin 95 is adhered, by coating, only to the trenches 12 in the concave-side surface of the crown section 91b of the pressure relief device 91 and their neighboring areas so as to fill the trenches with the resin; therefore, the inside walls and bottoms of and the neighboring areas of the trenches 12 in the pressure relief plate 91, where deterioration most likely develops, are not affected by rainwater, moisture or freezing, so that they neither corrode nor reduce their mechanical strength. For this reason, a pressure relief device in which silicone resin 95 is adhered, by coating, to its trenches 12 and their neighboring areas has higher reliability than that without adherence of the silicone resin 95. Therefore, also in a gas-insulated switchgear provided with the pressure relief device of Embodiment 2 according to the present invention, the corrosion or the deterioration in mechanical strength due to rainwater, moisture or freezing is less likely to occur, so that high reliability can be obtained. In the pressure relief device of Embodiment 2, because only the trenches 12 and their neighboring areas in the pressure relief plate 91 are coated with the silicone resin 95, the amount of expensive resin to be used can be reduced in comparison with that of Embodiment 1, bringing effects that a lightweight pressure relief device can be obtained at lower costs. Here, the hydrophobic synthetic resin used in Embodiment 2 according to the present invention is not necessarily the silicone resin; fluorine resin, fluorine rubber and the like that include fluorine may be used. The above effects are realized by any thin or thick coating with the hydrophobic synthetic resin; however, in view of moisture's entering into the synthetic resin, a thickness equal to or more than one micrometer has provided better reliability for a long term, and particularly a thickness from 50 to 2000 micrometers has worked well. In addition, a sheet of the hydrophobic synthetic resin may be adhered to the trenches 12 and their neighboring areas in the surface of the pressure relief plate 91 by heat welding, or by bonding with an adhesive.

### Embodiment 3

Referring to views, Embodiment 3 according to the present invention will be explained in detail below. FIG. 4 are outlined views in which the pressure relief device of Embodiment 1 according to the present invention is mounted on a gastight enclosure plate 7—the exterior portion of the gastight enclosure 5 of the gas-insulated switchgear. In FIG. 4, the components identical or equivalent to those in FIGS. 1 through 3 are referred to as the same numerals.

As shown in FIG. 4, a pressure relief device of Embodiment 3 according to the present invention differs from that of Embodiment 1 in that the device of Embodiment 3 is the one of Embodiment 1 provided with a pressure relief cover 96.

As shown in FIG. 4A, a side sectional view, the pressure relief cover 96 used in the pressure relief device 9 according to the present invention is fixed on the attachment plate 93 (so as to face the silicone resin 95 adhered by coating, and cover the resin); as shown in FIG. 4B-a top view, the cover, together with the attachment plate 93, is bolted with two bolts 94 to the gastight enclosure plate 7. Furthermore, in at least one of the sides of the pressure relief cover 96, a hole 96a is provided in order to release high pressure gas in the gastight enclosure 5 due to the burst of the pressure relief device 9. In addition, instead of providing the hole 96a in the side, the side itself in which the hole is provided could be removed.

In the pressure relief device of Embodiment 3 according to the present invention configured as described above, the pressure relief cover 96 with the hole 96a for releasing high pressure gas is provided; therefore, when the pressure relief device 9 bursts, only from the hole 96a there issue forth pressured-relief gas together with broken pieces of the pressure relief plate 91, the silicone resin 95 and the like. For this reason, if the hole 96a is formed net-like or provided with a net-like filter, the broken pieces of the pressure relief plate 91 and the silicone resin can be restrained from scattering and be prevented from directly issuing forth out of the pressure relief device 9. Therefore, the pressure relief device 9 can also prevent damages to the environment due to scattering of the broken pieces of the pressure relief plate 91 and the silicone resin 95 caused by the burst of the pressure relief device 9.

As has been described above in detail, in each of the pressure relief devices of Embodiments 1 through 3 according to the present invention, the pressure relief plate is placed between the attachment plate and the gastight enclosure of the gas-insulated switchgear in order to close the pressure relief hole of the gas-insulated switchgear; and the attachment plate is fixed to the gastight enclosure with a plurality of bolts. However, the bolts and the attachment plate are not necessarily used to fix the pressure relief plate to the gastight enclosure of the gas-insulated switchgear, thus the pressure relief plate may be directly or indirectly fixed to the gastight enclosure in order not to be detached from the gastight enclosure. For example, in order to close the pressure relief hole of the gastight enclosure, the hole's periphery could be directly brazed or bonded to the pressure relief plate; or, the pressure relief plate could be indirectly fixed by brazing the attachment plate to the gastight enclosure.

What is claimed is:

1. A pressure relief plate that closes a pressure relief hole formed in a gastight enclosure and bursts, when pressure in the gastight enclosure rises to a predetermined value, to relieve the pressure, the pressure relief plate provided with hydrophobic synthetic resin adhered to a surface thereof.

2. The pressure relief plate according to claim 1, wherein the pressure relief plate is in a hat shape that has a brim section and a crown section with a trench for triggering burst.

3. The pressure relief plate according to claim 2, wherein the hydrophobic synthetic resin is adhered to the trench provided on the crown section of the pressure relief plate and to the trench's vicinity.

4. The pressure relief plate according to claim 1, wherein the hydrophobic synthetic resin is a synthetic resin that includes either a silicone resin or a resin including fluorine.

5. The pressure relief plate according to claim 2, wherein the hydrophobic synthetic resin is a synthetic resin that includes either a silicone resin or a resin including fluorine.

6. The pressure relief plate according to claim 3, wherein the hydrophobic synthetic resin is a synthetic resin that includes either a silicone resin or a resin including fluorine.

7. A pressure relief device comprising:
the pressure relief plate according to claim 1; and
a mounting means that fixes the pressure relief plate onto the gastight enclosure.

8. The pressure relief device according to claim 7, wherein the pressure relief plate included in the pressure relief device is formed in a hat shape that has a brim section and a crown section with a trench for triggering burst.

9. The pressure relief device according to claim 8, wherein the hydrophobic synthetic resin is adhered to the trench provided on the crown section of the pressure relief plate included in the pressure relief device and to the trench's neighboring area.

10. The pressure relief device according to claim 7, wherein the hydrophobic synthetic resin is a synthetic resin that includes either a silicone resin or a resin including fluorine.

11. The pressure relief device according to claim 8, wherein the hydrophobic synthetic resin is a synthetic resin that includes either a silicone resin or a resin including fluorine.

12. The pressure relief device according to claim 9, wherein the hydrophobic synthetic resin is a synthetic resin that includes either a silicone resin or a resin including fluorine.

13. A gas-insulated switchgear provided with a gastight enclosure, wherein the pressure relief plate according to claim 1 is fixed to the gastight enclosure.

14. The gas-insulated switchgear according to claim 13, wherein the pressure relief plate provided in the gas-insulated switchgear is formed in a hat shape that has a brim section and a crown section with a trench for triggering burst.

15. The gas-insulated switchgear according to claim 14, wherein the hydrophobic synthetic resin is adhered to the trench provided on the crown section of the pressure relief plate included in the gas-insulated switchgear and to the trench's neighboring area.

16. The gas-insulated switchgear according to claim 13, wherein the hydrophobic synthetic resin is a synthetic resin that includes either a silicone resin or a resin including fluorine.

17. The gas-insulated switchgear according to claim 14, wherein the hydrophobic synthetic resin is a synthetic resin that includes either a silicone resin or a resin including fluorine.

18. The gas-insulated switchgear according to claim 13, further comprising a mounting means that fixes the pressure relief plate onto the gastight enclosure.

19. The gas-insulated switchgear according to claim 14, further comprising a mounting means that fixes the pressure relief plate onto the gastight enclosure.

20. The gas-insulated switchgear according to claim 15, further comprising a mounting means that fixes the pressure relief plate onto the gastight enclosure.
